(19) United States
(12) Patent Application Publication
(10) Pub. No.: US 2026/0360391 A1
(43) Pub. Date: Nov. 12, 2026

(54) IMAGING DEVICE, IMAGE PROCESSING METHOD, AND PROGRAM

(71) Applicant: Sony Group Corporation, Tokyo (JP)

(72) Inventor: Tohru KURATA, Kanagawa (JP)

(73) Assignee: Sony Group Corporation, Tokyo (JP)

(21) Appl. No.: 19/665,704

(22) Filed: May 1, 2026

(30) Foreign Application Priority Data
May 9, 2025 (JP) 2025-078412

(51) Int. Cl. G11B 27/031; G06T 7/60

(52) U.S. Cl. CPC G11B 27/031; G06T 7/60; G06T 2207/10016; G06T 2207/30201

(57) ABSTRACT

There is provided an imaging device to implement cutout processing in which a composition changes according to a subject size. The imaging device includes a composition data storage unit that stores a plurality of pieces of composition data having different subject sizes and different frame size ratios, and a cutout operation unit that determines a subject size in a frame of captured image data, sets a cutout frame on the basis of a plurality of pieces of composition data selected from the composition data storage unit according to a subject size of the captured image data and a size ratio of the frame, and performs cutout processing on the frame of the captured image data.

### CROSS REFERENCE TO RELATED APPLICATIONS

This application claims the benefit of Japanese Priority Patent Application JP 2025-078412 filed on May 9, 2025, the entire contents of which are incorporated herein by reference.

### TECHNICAL FIELD

The present technology relates to an imaging device, an image processing method, and a program, and particularly relates to cutout processing on a captured image.

### BACKGROUND ART

In various imaging devices such as a digital camera and a smartphone having a photographing function, there is an imaging device having a function of cutting out and recording a part of a captured image. In particular, processing of tracking a target subject in a moving image frame and cutting out an image of the target subject is known.

PTL 1 below discloses a technique for tracking a target subject.

### CITATION LIST

### Patent Literature

### [PTL 1]

JP 2007-328746 A

### SUMMARY

### Technical Problem

As an automatic tracking framing function in the imaging device, there is a function of cutting out and recording a range such as bust up from each frame of a captured moving image by the user designating a composition such as bust up and the entire body in advance. However, in this function, even in a case where the size of the subject in the image is changed due to a change in the distance to the subject being imaged, the same composition is applied, and an image not intended by the user or an unnatural image may be obtained.

Therefore, it is desirable to obtain an unnatural cutout image in a case where a specific subject is tracked and cutout is performed as in an automatic tracking framing function.

### Solution to Problem

An imaging device according to the present technology includes a composition data storage unit that stores a plurality of pieces of composition data having a different ratio between a subject size and a size of a frame, and a cutout operation unit that determines a subject size in a frame of captured image data, sets a cutout frame on the basis of a plurality of pieces of composition data selected from the composition data storage unit according to a subject size of the captured image data and a size ratio of the frame, and performs cutout processing on the frame of the captured image data.

That is, a plurality of pieces of composition data according to the ratio between the subject size and the frame is prepared, and a cutout frame is set from the plurality of pieces of composition data according to the subject size and the frame of the actual captured image data.

### BRIEF DESCRIPTION OF DRAWINGS

FIG. 1 is a block diagram of an imaging device according to an embodiment of the present technology.

FIG. 2 is a block diagram of a cutout processing configuration of automatic tracking framing according to the embodiment.

FIG. 3 is an explanatory diagram of a composition data table according to the embodiment.

FIG. 4 is an explanatory diagram of a composition data table according to the embodiment.

FIG. 5 is a flowchart of cutout processing according to the embodiment.

FIG. 6 is a flowchart of subject size determination processing according to the embodiment.

FIG. 7 is an explanatory diagram of interpolation processing of composition data and cutout frame setting according to the embodiment.

### DESCRIPTION OF EMBODIMENTS

Hereinafter, embodiments will be described in the following order.
<1. Configuration of imaging device>
<2. Cutout processing configuration>
<3. Processing example>
<4. Summary and modification>

Note that, in the present disclosure, an “image” includes a moving image and a still image. In the embodiment, moving image capturing is mainly assumed, but the technology of the present disclosure can also be applied to still image capturing.

### 1. Configuration of Imaging Device

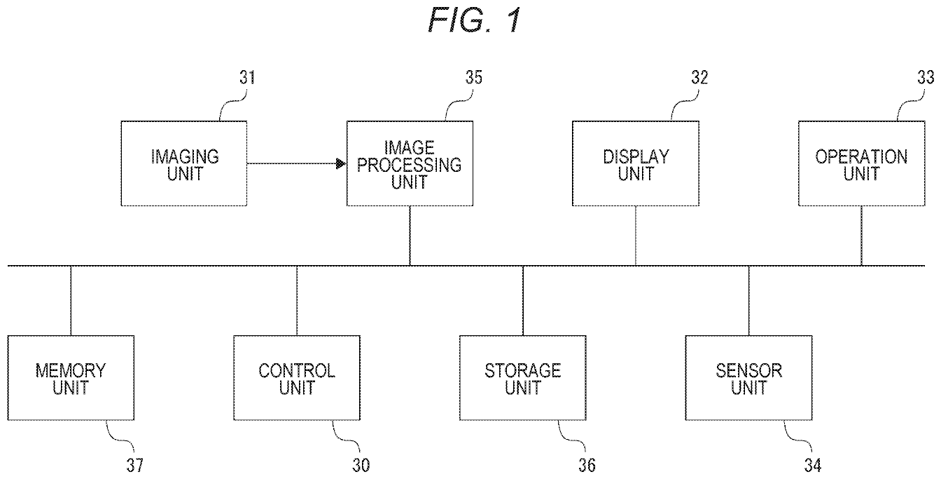

FIG. 1 illustrates a configuration example of an imaging device 1 according to the embodiment.

Note that the imaging device 1 is realized in a form of a digital camera, a form as a smartphone, a tablet device, or the like having an imaging function.

The imaging device 1 includes a control unit 30, an imaging unit 31, a display unit 32, an operation unit 33, a sensor unit 34, an image processing unit 35, a storage unit 36, and a memory unit 37. Note that the configuration in FIG. 1 is merely an example illustrating main parts, and a configuration not illustrated may be included, and it is not necessary to include all the configurations illustrated.

The imaging unit 31 includes a lens unit, an image sensor that receives incident light corresponding to one or a plurality of lenses in the lens unit, and a processing circuit for signals photoelectrically converted by the image sensor. The lens unit in the imaging unit 31 includes an optical system such as a zoom lens, a focus lens, and a diaphragm mechanism, a drive mechanism of these optical elements, and the like. With this optical system, light from the subject is guided and condensed on the image sensor.

The image sensor in the imaging unit 31 is of, for example, a charge coupled device (CCD) type, a complementary metal oxide semiconductor (CMOS) type, or the like. The image sensor performs, for example, correlated double sampling (CDS) processing, automatic gain control (AGC) processing, or the like on an electrical signal obtained by executing photoelectric conversion on received light, and also performs analog/digital (A/D) conversion processing. Then, the captured image data as digital data is output to the image processing unit 35.

The image processing unit 35 is configured as, for example, an image processing processor.

The image processing unit 35 performs, on the captured image data captured by the imaging unit 31 and input, processing such as, for example, Y/C development processing, codec processing, and file generation processing. Image data of the moving image and the still image output through these processing by the image processing unit 35 is stored in the storage medium by the storage unit 36.

Note that, as will be described later, the image processing unit 35 also performs cutout processing as automatic tracking framing.

The display unit 32 includes the display panel and a display drive circuit thereof, and performs various displays for the user. The display panel includes a liquid crystal display (LCD) panel, an organic electro-luminescence (EL) panel, or the like.

The display unit 32 executes various displays on a display screen on the basis of an instruction from the control unit 30. For example, the display unit 32 displays a preview image (monitor image) and a reproduced image at the time of photographing, and displays various icons, operation members, and the like as a user interface.

The operation unit 33 generically represents input devices provided for the user to input various operations. Specifically, the input devices are a physical operation member such as a shutter button, and a touch panel that detects an operation on an operation member (button, icon, slider, or the like) displayed on the display unit 32, and the like.

An operation by the user is sensed by the operation unit 33, and a signal corresponding to the input operation is transmitted to the control unit 30.

The sensor unit 34 represents various sensors mounted on the imaging device 1.

The sensor unit 34 is equipped with an inertial measurement unit (IMU), for example, and can detect an angular velocity with an angular velocity (gyro) sensor of three axes of pitch, yaw, and roll, for example, and detect acceleration with an acceleration sensor.

Furthermore, as the sensor unit 34, an illuminance sensor may be mounted.

Furthermore, as the sensor unit 34, for example, a distance measuring sensor such as a time of flight (TOF) sensor may be mounted.

Each kind of information detected by the sensor unit 34, such as illuminance information, IMU data, distance measuring data, for example, is supplied to the control unit 30 and the image processing unit 35.

On a recording medium such as a non-volatile memory for example, the storage unit 36 performs processing of recording an image file (content file) of still image data, moving image data, or the like, attribute information of the image file, a thumbnail image, and the like.

Various actual forms of the storage unit 36 are conceivable. For example, the storage unit 36 may be a circuit unit that performs recording/reproducing with respect to a flash memory built in the imaging device 1, or may be a card recording/reproducing circuit that performs recording/reproducing access to a memory card (for example, a portable flash memory) attachable to and detachable from the imaging device 1. Furthermore, the storage unit 36 may be implemented as a hard disk drive (HDD), a solid state drive (SSD), or the like as an aspect incorporated in the imaging device 1.

The control unit 30 includes a processor (arithmetic processing unit) such as a central processing unit (CPU). The memory unit 37 stores information and the like used by the control unit 30 for processing. The memory unit 37 includes, for example, a read only memory (ROM), a random access memory (RAM), a flash memory, and the like.

The memory unit 37 may be a memory area built in a microcomputer chip serving as the control unit 30 or may include a separate memory chip.

The RAM in the memory unit 37 is used to temporarily store data, programs, and the like as a work area for during various types of data processing performed by the CPU of the control unit 30.

The ROM and the flash memory (non-volatile memory) in the memory unit 37 are used to store an operating system (OS) for the CPU of the control unit 30 to control each unit, application programs for the control unit 30 or the processor of the image processing unit 35 to perform various operations, various types of setting information, and the like.

The control unit 30 executes a program stored in the ROM, the flash memory, or the like of the memory unit 37 to control the entire imaging device 1.

For example, the control unit 30 performs control for zooming, focusing, aperture adjustment, and the like on the optical system of the imaging unit 31, control of shutter speed for the image sensor, signal processing on the captured image data, an imaging operation and recording operation according to operation by the user, operation of reproducing the recorded image file, and the like.

Note that, although the image processing unit 35 and the control unit 30 are illustrated separately in the drawing, they may be formed by one processor.

### 2. Cutout Processing Configuration

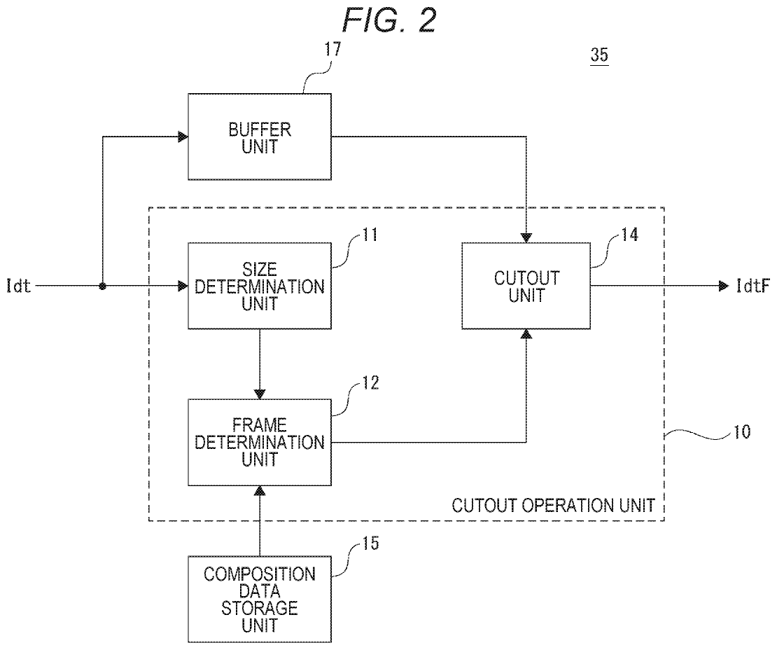

FIG. 2 illustrates a processing function of automatic tracking framing in the image processing unit 35. That is, FIG. 2 illustrates a configuration of processing of automatically tracking a subject in captured image data and cutting out the subject with an appropriate composition to generate a recorded image.

As a configuration for automatic tracking framing, the image processing unit 35 includes a cutout operation unit 10 and a buffer unit 17. Furthermore, the image processing unit 35 can refer to a composition data storage unit 15 formed in an internal or external memory.

A captured image data Idt is image data captured by the imaging unit 31 and subjected to the predetermined processing in the preceding stage in the image processing unit 35. As the captured image data Idt, each frame in the moving image data during moving image capturing is to be processed by the cutout operation unit 10.

The buffer unit 17 buffers the captured image data Idt of each frame in order to match the processing timing in consideration of the delay due to the processing of the cutout operation unit 10. Note that the buffer unit 17 may not be provided. This is because there may be a slight deviation between the cutout frame set by the cutout operation unit 10 and the frame to be cut out.

The cutout operation unit 10 includes a size determination unit 11, a frame setting unit 12, and a cutout unit 14.

The size determination unit 11 performs processing of determining the subject size in the frame of the input captured image data Idt. The information that is the Source of the subject size is the position and size of the face, the position of the human skeleton point, and the like according to the human body detection technology, and the size determination unit 11 estimates the subject size from these. Note that the subject size determined by the size determination unit 11 is obtained for composition setting, that is, cutout range setting, and does not require a precise area of the pixel region of the subject person in the frame. In the frame range, how much area the subject person occupies may be roughly known. Therefore, the subject size may be obtained as the area of the body frame, the area of the face frame, and the like described later.

The frame setting unit 12 performs processing of setting a cutout frame. That is, the frame setting unit 12 performs processing of selecting one or two or more pieces of the composition data from the composition data storage unit 15 according to the ratio between the subject size determined by the size determination unit 11 and the size of the frame of the captured image data Idt, and setting the cutout frame on the basis of the selected one or two pieces of the composition data.

The composition data storage unit 15 stores a plurality of pieces of composition data as a composition data table. Each of the plurality of pieces of composition data is composition data according to the ratio between the subject size and the size of the frame.

For example, a processor as the image processing unit 35 stores a plurality of pieces of composition data FD in an internal memory and includes a composition data storage unit 15. Alternatively, the composition data storage unit 15 may be provided in the memory unit 37 so that the image processing unit 35 can sequentially refer to the composition data FD of the memory unit 37.

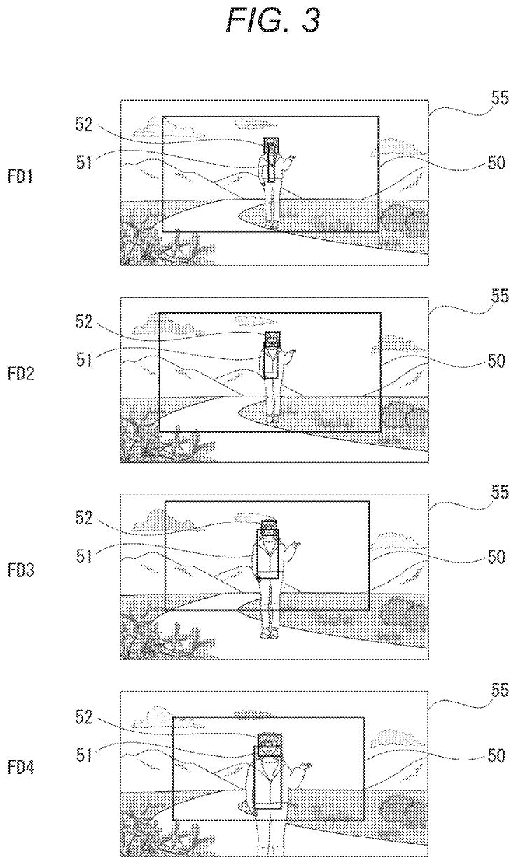

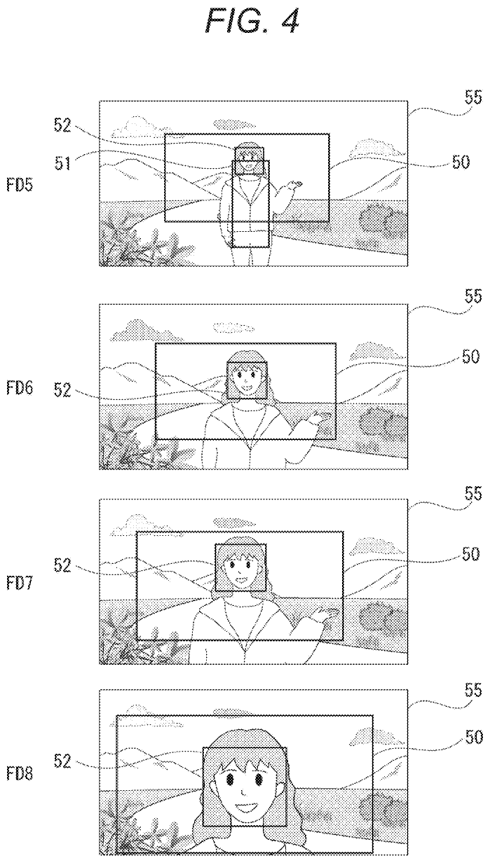

FIGS. 3 and 4 illustrate eight pieces of composition data stored in the composition data storage unit 15. Note that eight is merely an example for description.

Furthermore, FIGS. 3 and 4 illustrate composition data in a case where, for example, the user “laterally holds” the imaging device 1 and captures an image of a horizontally long frame. In addition to this, the composition data table to be applied to “vertically holding vertically long frame” and the like may also be stored in the composition data storage unit 15.

FIGS. 3 and 4 illustrate composition data FD1 to composition data FD8 as eight pieces of composition data. For the sake of description, in a case where the composition data FD8 to the composition data FD1 are not distinguished, it is described as “composition data FD”.

The composition data FD is data in which the size of a cutout frame 50 and the representative position in the frame are set with respect to a frame 55, that is, the entire frame of one frame. The representative position may be information indicating a specific position in the cutout frame 50, and may be, for example, central coordinates of the subject region, specific skeleton coordinates, or the like. Hereinafter, an example in which the representative position is a central coordinate will be described. For example, cutout frame 50 set by the central coordinates and the size indicates the composition of the image cut out from the frame.

The composition data FD1 to the composition data FD8 are data of the cutout frames 50 having different sizes and central coordinates as illustrated in the drawing. These cutout frames 50 have a size and central coordinates that are set in advance to have an appropriate composition according to the ratio between the subject size and the frame size.

That is, each composition data FD is data in which the cutout frame 50, which is a composition, is set according to the size (subject size) of the subject person in the frame 55.

The composition data FD1 to the composition data FD8 are data in which the subject size in the frame gradually increases.

In the composition data FD1, in a case where the entire body of the subject person is the smallest, the cutout frame 50 including the entire body of the person is set.

The composition data FD2 is also in a case where the entire body of the subject person is included, and the cutout frame 50 whose frame size is slightly increased according to the subject size is set.

In the composition data FD3 and FD4, the cutout frame 50 in a range from the vicinity of the knee or waist to the top of the head is set according to the increase in the subject size.

In the composition data FD5, FD6, and FD7, the cutout frame 50 in the bust up range is set according to the increase in the subject size.

In the composition data FD8, the cutout frame 50 that mainly cuts out the face range is set according to the increase in the subject size.

As described above, in each composition data FD, the cutout frame 50 having an appropriate composition is set according to the ratio between the subject size and the size of the frame 55, that is, the proportion of the subject in the frame 55.

The size of the cutout frame 50 is, for example, the size in the x coordinate direction and the y coordinate direction, and the central coordinates are coordinate values in which the center point of the cutout frame 50 is located within the x and y coordinates of the frame.

In the composition data FD1, FD2, FD3, FD4, and FD5, the area of a body frame 51 is set as the subject size, and the size and central coordinates of the cutout frame 50 are set according to the ratio between the area of the frame 55 and the area of the body frame 51. The body frame 51 is a frame set from a skeleton point or the like of the body.

The composition data FD6, FD7, and FD8 are data in which the body frame 51 is difficult to be determined, the area of a face frame 52 is set as the subject size, and the size and central coordinates of the cutout frame 50 are set according to the ratio between the area of the frame 55 and the area of the face frame 52.

The plurality of pieces of composition data FD are stored in the composition data storage unit 15 as described above.

From such composition data FD, the frame setting unit 12 selects one or two pieces of the composition data FD according to the ratio between the subject size and the frame size in the frame of the current captured image data Idt.

The subject size in the frame of the current captured image data Idt determined by the size determination unit 11 is also the area of the body frame 51 or the face frame 52 described above. Therefore, the frame setting unit 12 calculates the ratio between the subject size and the frame size in the frame of the current captured image data Idt, and selects composition data FD having the same ratio.

However, actually, there are few composition data FD having the same ratio among the eight composition data FD, and in many cases, the frame setting unit 12 selects two pieces of the composition data FD having close ratios. By performing linear interpolation using the two pieces of the composition data FD, the composition data (hereinafter, referred to as “interpolation composition data FDc”) suitable for the subject size in the frame of the current captured image data Idt can be generated.

The composition data FD or the interpolation composition data FDc having the same ratio as described above is information of the cutout frame 50 having a composition adapted to the subject size in the frame of the current captured image data Idt. That is, it is information on the size and central coordinates of the cutout frame 50 adapted to the subject size in the frame of the current captured image data Idt.

The frame setting unit 12 generates information of a cutout frame 50c to be actually used for the cutout processing on the frame of the current captured image data Idt on the basis of the information of the size of the cutout frame 50 and the central coordinates, and gives the information to the cutout unit 14.

The cutout unit 14 reads the frame corresponding to the supplied information of the cutout frame 50c from the buffer unit 17, and performs the cutout processing using the supplied information of the cutout frame 50c on the processing target frame.

The cutout operation unit 10 performs the above-described processing of the size determination unit 11, the frame setting unit 12, and the cutout unit 14 for each frame of the captured image data Idt.

Therefore, the image thus cut out becomes captured image data IdtF as the automatic tracking framing moving image. The captured image data IdtF is stored as a moving image file in the storage unit 36, for example.

### 3. Processing Example

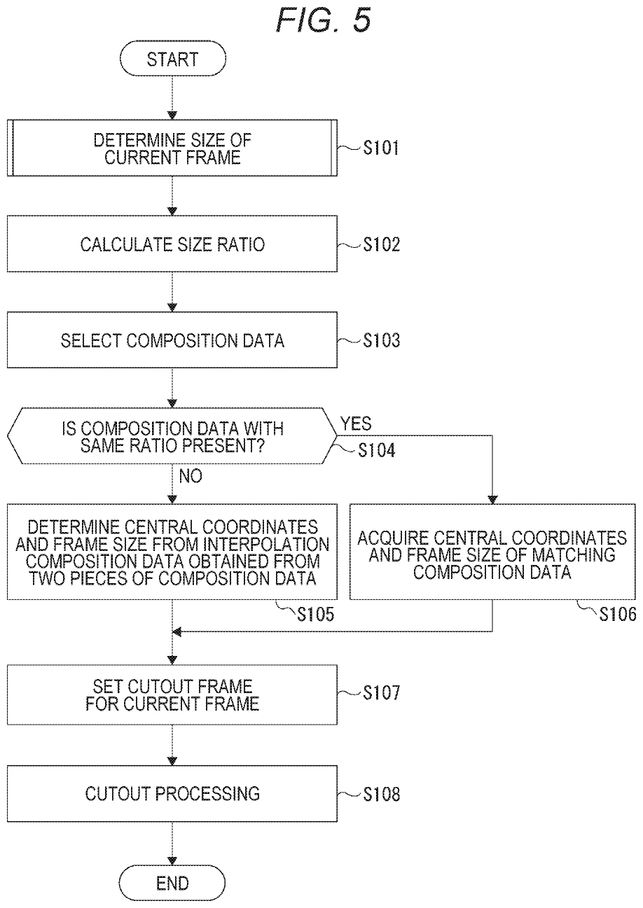

A specific processing example will be described with reference to FIGS. 5, 6, and 7.

FIG. 5 is a processing example executed by the image processing unit 35 by the function of the cutout operation unit 10 for each frame of the captured image data Idt.

In step S101, the image processing unit 35 determines the subject size of the input current frame. For the sake of explanation, the current frame is referred to as a “frame FRc”.

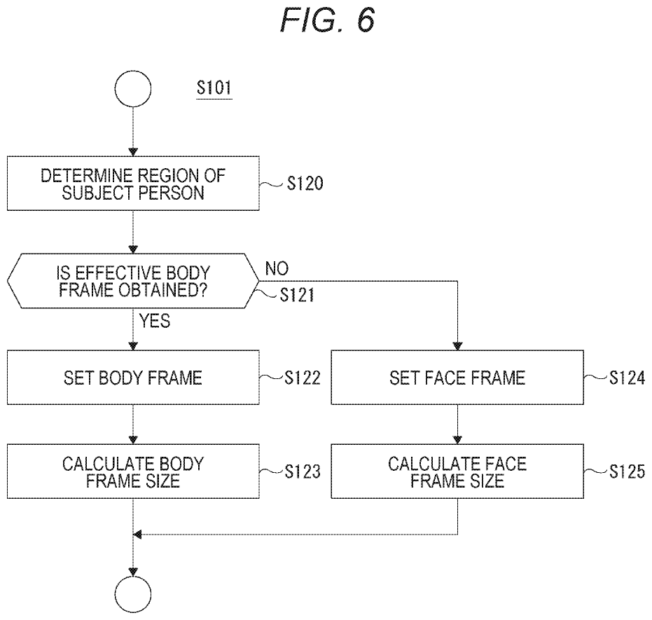

FIG. 6 illustrates an example of the processing in step S101.

In step S120, the image processing unit 35 determines a region of the subject person in the frame FRc. In this case, the position of the face and the human skeleton point are detected, and the pixel region in which the person of the subject is captured is determined.

In step S121, the image processing unit 35 branches the processing depending on whether or not a valid body frame 51 can be determined within the frame 55. For example, by detecting a human skeleton point, it is possible to determine which part of the human figure is captured.

For example, it is assumed that the body frame 51 is obtained when a portion corresponding to the body frame 51 is captured, such as the entire body or from the upper knee to the top of the head.

In this case, the image processing unit 35 proceeds to step S122, and sets the body frame 51 in the frame FRc. Note that, the face frame 52 may be set at the same time. Then, in step S123, the image processing unit 35 calculates the size (area) of the body frame 51 as the subject size.

For example, in a case where it is determined in step S121 that the body frame 51 is difficult to be obtained in the frame FRc because the person is captured only from the chest to the top of the head, the image processing unit 35 proceeds to step S124 and sets the face frame 52 in the frame FRc.

Then, in step S125, image processing unit 35 calculates the size (area) of the face frame 52 as the subject size. Through the above processing of FIG. 6, the image processing unit 35 proceeds to step S102 of FIG. 5. In step S102, the image processing unit 35 calculates the ratio between the subject size and the frame size.

The size ratio is a ratio of the body frame 51 to the frame FRc or a ratio of the face frame 52 to the frame FRc.

In step S103, the image processing unit 35 selects composition data FD having a matching size ratio or two pieces of the composition data FD having close size ratios from the plurality of pieces of composition data FD stored in the composition data storage unit 15.

In a case where the composition data FD having a matching size ratio exists and is selected, the image processing unit 35 proceeds to step S106 and acquires information of the cutout frame 50 in the composition data FD. That is, it is information on the size and central coordinates of the cutout frame 50.

On the other hand, in a case where there is no composition data FD having a matching size ratio and two pieces of the composition data FD having close size ratios are selected, the image processing unit 35 proceeds to step S105. Then, image processing unit 35 generates interpolation composition data FDc by linear interpolation processing of two pieces of the composition data FD, and acquires information of the cutout frame 50 in the interpolation composition data FDc. That is, it is information on the size and central coordinates of the cutout frame 50.

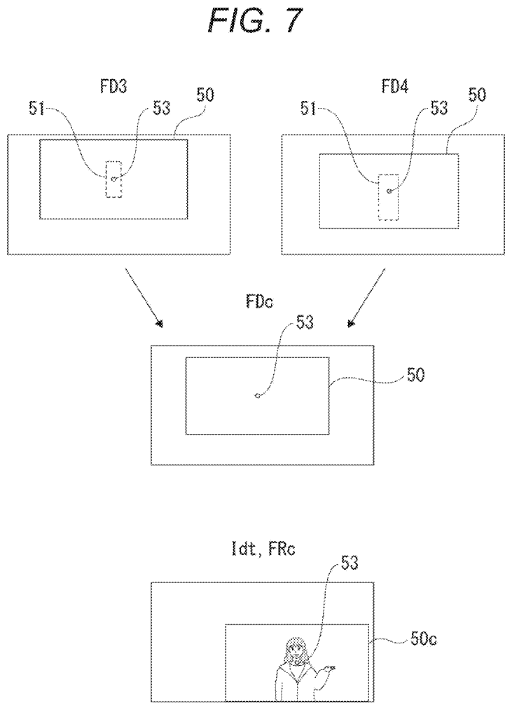

This will be described with reference to FIG. 7. It is assumed that the composition data FD3 and FD4 are Selected as composition data FD having a close size ratio.

First, a weight w1 for the composition data FD3 and a weight w2 for the composition data FD4 are calculated from a difference between the size ratio in the frame FRc to be processed and the size ratio of the composition data FD3 and the size ratio in the frame FRc to be processed and the size ratio of the composition data FD4.

Then, interpolation processing reflecting the weights w1 and w2 described above is performed on the size SZ3 of the cutout frame 50 of the composition data FD3 and the size SZ4 of the cutout frame 50 of the composition data FD4, whereby the size SZc of the cutout frame 50 of the interpolation composition data FDc is obtained.

Similarly, the interpolation processing reflecting the weights w1 and w2 described above is performed on the central coordinates 53 (x3, y3) of the cutout frame 50 of the composition data FD3 and the central coordinates 53 (x4, y4) of the cutout frame 50 of the composition data FD4, whereby the central coordinates 53 (xc, yc) of the cutout frame 50 of the interpolation composition data FDc are obtained. Therefore, the interpolation composition data FDc can be calculated as illustrated in the drawing.

That is, information on the size and central coordinates of the cutout frame 50 as interpolation composition data FDc is obtained.

In step S107 of FIG. 5, the image processing unit 35 sets the cutout frame 50c for the frame FRc on the basis of the size and central coordinates of the cutout frame 50 as the interpolation composition data FDc obtained in step S105, or the size and central coordinates of the cutout frame 50 obtained in step S106.

The size and central coordinates obtained by the interpolation composition data FDc or the selected composition data FD are information based on the preset position of the person subject, and are different from the position of the person subject in the current frame FRc. That is, a deviation occurs between the coordinates of the specific position of the person subject and the central coordinates 53. The specific position of the person subject is, for example, a position of a specific body part or the like desired to be set as the center in the person subject.

Therefore, as illustrated in FIG. 7, information of the cutout frame 50c in which the central coordinates 53 are moved is set according to the position of the person subject of the frame FRc.

In step S108 of FIG. 5, the image processing unit 35 performs cutout processing on the frame FRc on the basis of the information of the cutout frame 50c corresponding to the frame FRc. Therefore, the captured image data IdtF as the frame FRc is output.

### 4. Summary and Modification

According to the above-described embodiments, the following effects can be obtained.

The imaging device 1 according to the embodiment includes, in the image processing unit 35 and the like, a composition data storage unit 15 that stores a plurality of pieces of composition data FD according to the ratio between the subject size and the size of the frame, and a cutout operation unit 10. The cutout operation unit 10 determines the subject size in the frame of the captured image data Idt, selects two pieces of the composition data FD from the composition data storage unit 15 according to the ratio between the subject size of the captured image data Idt and the size of the frame, sets the cutout frame 50c on the basis of the plurality of pieces of composition data FD, and performs the cutout processing on the frame of the captured image data Idt.

Therefore, this enables cutout processing in which the composition automatically changes according to the size of the subject, and a more desirable automatic tracking framing image can be obtained.

For example, even if the subject moves and the apparent size changes, an image smoothly transitioning to an optimum composition can be obtained. Furthermore, in a case where the subject becomes small, even in a case where the frame size becomes relatively large in order to maintain the sense of resolution of the recorded image, an image that changes to an optimum composition with a large size can be obtained. As a result, the cutout moving image content of the automatic tracking framing is recorded as a more preferable composition for the user.

Note that, in the embodiment, cutout frame 50c is set on the basis of two pieces of composition data FD.

Alternatively, cutout frame 50c may be set based on three or more pieces of composition data FD. For example, by using spline interpolation of drawing a cubic curve from four composition data FD having close size ratios, inflection points are smoothly connected, which is suitable for application in the present technology. The composition data FD according to the embodiment is data including information on the size of the cutout frame 50 and the representative position (for example, central coordinates).

Therefore, the central coordinates and size of the cutout frame 50 suitable for the current frame FRc to be processed are obtained from the plurality of pieces of composition data FD. Therefore, the cutout frame 50 according to the subject size of each frame can be set.

In the embodiment, an example has been described in which the cutout operation unit 10 selects a plurality of pieces of composition data FD having a size ratio close to the ratio between the subject size and the size of the frame of the captured image data from the composition data FD stored in the composition data storage unit 15, and sets the interpolation composition data FDc including the representative position and size of the cutout frame 50 by linear interpolation using the plurality of pieces of composition data FD.

Therefore, for the ratio between the subject size and the frame size, the interpolation composition data FDc is generated from, for example, two pieces of the composition data FD close to the frame of the current captured image data. This interpolation composition data FDc is composition data according to the size ratio of the current frame, that is, data having information of the central coordinates and the size of the cutout frame 50. By using the interpolation composition data FDc in this way, it is not necessary to unintentionally increase the number of composition data FD stored in the composition data storage unit 15, and the composition data table size can be reduced.

Note that the interpolation processing may be performed using three or more composition data FD including two pieces of the composition data FD having close size ratios.

In the embodiment, an example has been described in which the cutout operation unit 10 sets the cutout frame 50c according to the difference between the representative position in the interpolation composition data FDc and the specific position coordinates of the subject in the frame of the captured image data, and performs the cutout processing.

That is, using the information of the central coordinates and the size of the cutout frame 50 in the interpolation composition data FDc suitable for the current frame obtained by the interpolation processing, the cutout frame 50c is set such that the central coordinates and the size are matched with the position of the subject in the current frame. Therefore, the cutout processing can be performed in the cutout frame 50c suitable for the position and size of the subject in the current frame.

In the embodiment, an example has been described in which the captured image data Idt is a moving image, and the cutout operation unit 10 determines the subject size for each frame, selects a plurality of pieces of composition data FD from the composition data storage unit 15 according to the ratio between the subject size and the size of the frame of the captured image data Idt, sets the cutout frame 50c on the basis of the plurality of pieces of composition data FD, and performs the cutout processing.

Therefore, automatic tracking framing in which the cutout frame 50c changes without discomfort according to the size and position of the subject is realized.

In the embodiment, an example has been described in which the plurality of pieces of composition data FD including the composition data FD serving as the cutout frame 50 including the entire body of the subject, the composition data FD serving as the cutout frame 50 that cuts out the periphery of the face from the chest of the subject, and the composition data FD serving as the cutout frame 50 that cuts out the periphery of the face of the subject are stored in the composition data storage unit 15.

When the composition data FD having different cutout ranges such as the entire body, bust up, and face is prepared according to the size ratio between the subject size and the frame size, the composition including the entire body, the composition of bust up, the composition of face up, and the like are automatically selected by selecting the composition data FD. Therefore, the composition type is automatically selected according to the subject size of the current frame.

In the embodiment, an example has been described in which the cutout operation unit 10 determines the size of the body frame 51 set for the subject person as the subject size in the frame of the captured image data Idt, and obtains the size ratio between the body frame 51 and the frame 55.

For example, when the body frame 51 of the subject person can be taken, the size ratio between the size of the body frame 51 and the size of the frame 55 is obtained. The composition data FD including the entire body can be applied by selecting the composition data FD according to the size ratio.

In the embodiment, an example has been described in which, in a case where the body frame 51 is difficult to be set for the subject person in the frame of the captured image data Idt, the cutout operation unit 10 determines the size of the face frame 52 set for the subject person as the subject size, and obtains the size ratio between the face frame 52 and the frame 55.

In a case where the body frame 51 of the subject person is difficult to be obtained, the composition data FD is selected according to the size ratio between the size of the face frame 52 and the size of the frame 55, so that the composition data FD of bust up or face up can be applied.

Note that, although the description has been given assuming that a moving image is captured, the captured image data Idt may be a preview image at the time of capturing a still image. Moreover, the captured image data Idt may be a still image.

Furthermore, although the automatic tracking framing has been described with an example in which a person is a subject, the present technology can also be applied to a subject other than a person, such as an animal.

A program in the embodiment is a program for causing the information processing device of, for example, a CPU, a DSP, or the like, or a device including one of these to execute processes as illustrated in FIGS. 5 and 6.

That is, the program of the embodiment is a program for causing the image processing unit 35 to execute processing of determining the subject size in the frame of the captured image data Idt, setting the cutout frame 50c on the basis of the plurality of pieces of composition data FD selected according to the ratio between the subject size of the captured image data and the size of the frame from the plurality of pieces of composition data FD having a different ratio between the subject size and the size of the frame, and performing cutout on the frame of the captured image data with the set cutout frame 50c.

Such a program is implemented in an image processing unit in a digital camera or included in, for example, a camera application of a smartphone, thereby implementing the functions of the present embodiment.

Such a program can be recorded in advance in an HDD as a recording medium built in a device such as a computer device, a ROM in a microcomputer having a CPU, and the like.

Alternatively, the program can be temporarily or permanently stored (recorded) in a removable storage medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card.

Such a removable storage medium can be provided as what is called package software.

Furthermore, such a program can be installed from the removable storage medium into the personal computer and the like, or can be downloaded from a download site through a network such as a local area network (LAN) or the Internet.

Furthermore, such a program is suitable for providing the imaging device 1 according to the embodiment in a wide range. By downloading the program to a mobile terminal device such as a smartphone or a tablet, an imaging device, a mobile phone, a personal computer, a gaming device, or the like, for example, the smartphones or the like can function as the imaging device 1 in the present disclosure.

Note that the effects described in the present specification are merely examples and are not limited, and other effects may be provided.

Note that the present technology can also adopt the following configurations.
(1)

An imaging device including:
a composition data storage unit that stores a plurality of pieces of composition data having a different ratio between a subject size and a size of a frame; and
a cutout operation unit that determines a subject size in a frame of captured image data, sets a cutout frame on the basis of a plurality of pieces of composition data selected from the composition data storage unit according to a subject size of the captured image data and a size ratio of the frame, and performs cutout processing on the frame of the captured image data.
(2)

The imaging device according to (1), in which the composition data is data including information on a size of a cutout frame and a representative position.
(3)

The imaging device according to (1) or (2), in which the cutout operation unit selects, from the composition data stored in the composition data storage unit, a plurality of pieces of composition data in which a ratio between a subject size and a size of a frame is close to a ratio between a subject size and a size of a frame of the captured image data, and sets interpolation composition data including a representative position and a size of a cutout frame by linear interpolation using the plurality of pieces of selected composition data.
(4)

The imaging device according to (3), in which the cutout operation unit sets a cutout frame according to a difference between a representative position in the interpolation composition data and coordinates of a specific position of a subject in a frame of the captured image data, and performs the cutout processing.
(5)

The imaging device according to any one of (1) to (4), in which
the captured image data is moving image data, and
the cutout operation unit determines a subject size for each frame, selects a plurality of pieces of composition data from the composition data storage unit according to a ratio between the subject size and a size of a frame of the captured image data, sets a cutout frame on the basis of the plurality of pieces of composition data, and performs the cutout processing.
(6)

The imaging device according to any one of (1) to (5), in which
the composition data storage unit stores a plurality of pieces of composition data including:
composition data as a cutout frame including a whole body of a subject;
composition data as a cutout frame for cutting out a periphery of a face from a chest of the subject; and composition data as a cutout frame for cutting out a periphery of a face of a subject.
(7)

The imaging device according to any one of (1) to (6), in which
the cutout operation unit is configured to:
determine a size of a body frame set for a subject person as a subject size in a frame of captured image data, and
obtain a ratio between a size of the body frame and a size of a frame.
(8)

The imaging device according to (7), in which
the cutout operation unit is configured to:
in a case where the body frame is difficult to be set for a subject person in a frame of captured image data,
determine a size of a face frame set for a subject person as a subject size in a frame of captured image data, and
obtain a ratio between a size of the face frame and a size of a frame.
(9)

An image processing method for causing an image processing device to execute:
determining a subject size in a frame of captured image data;
setting a cutout frame on the basis of a plurality of pieces of composition data selected according to a ratio between a subject size of captured image data and a size of a frame among a plurality of pieces of composition data having different a ratio between a subject size and a size of a frame; and
performing cutout processing on a frame of captured image data with a set cutout frame.
(10)

A program for causing an image processing device to execute processing of:
determining a subject size in a frame of captured image data;
setting a cutout frame on the basis of a plurality of pieces of composition data selected according to a ratio between a subject size of captured image data and a size of a frame among a plurality of pieces of composition data having a different ratio between a subject size and a size of a frame; and
performing cutting on a frame of captured image data with a set cutout frame.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Imaging device
10 Cutout operation unit
11 Size determination unit
12 Frame setting unit
13 Buffer unit
14 Cutout unit
15 Composition data storage unit
35 Image processing unit
37 Memory unit
50, 50c Cutout frame
51 Body frame
52 Face frame
55 Frame

1. An imaging device comprising:
a composition data storage unit that stores a plurality of pieces of composition data having different ratios between a subject size and a frame size; and
a cutout operation unit that determines a subject size in a frame of captured image data, sets a cutout frame on a basis of a plurality of pieces of composition data selected from the composition data storage unit according to a ratio between a subject size and a frame size of the captured image data, and performs cutout processing on the frame of the captured image data.

2. The imaging device according to claim 1, wherein the composition data is data including information on a size of a cutout frame and a representative position.

3. The imaging device according to claim 1, wherein the cutout operation unit selects, from the composition data stored in the composition data storage unit, a plurality of pieces of composition data in which a ratio between a subject size and a frame size is close to a ratio between a subject size and a frame size of the captured image data, and sets interpolation composition data including a representative position and a size of a cutout frame by linear interpolation using the plurality of pieces of selected composition data.

4. The imaging device according to claim 3, wherein the cutout operation unit sets a cutout frame according to a difference between a representative position in the interpolation composition data and a specific position of a subject in a frame of the captured image data, and performs the cutout processing.

5. The imaging device according to claim 1, wherein
the captured image data is moving image data, and
the cutout operation unit determines a subject size for each frame, selects a plurality of pieces of composition data from the composition data storage unit according to a ratio between a subject size and a frame size of the captured image data, sets a cutout frame on a basis of the plurality of pieces of composition data, and performs the cutout processing.

6. The imaging device according to claim 1, wherein
the composition data storage unit stores a plurality of pieces of composition data including:
composition data as a cutout frame including a whole body of a subject;
composition data as a cutout frame for cutting out a periphery of a face from a chest of the subject; and
composition data as a cutout frame for cutting out a periphery of a face of a subject.

7. The imaging device according to claim 1, wherein
the cutout operation unit is configured to:
determine a size of a body frame set for a subject person as a subject size in a frame of captured image data, and obtain a ratio between a size of the body frame and a frame size.

8. The imaging device according to claim 7, wherein
the cutout operation unit is configured to:
in a case where the body frame is difficult to be set for a subject person in a frame of captured image data, determine a size of a face frame set for a subject person as a subject size in a frame of captured image data, and obtain a ratio between a size of the face frame and a frame size.

9. An image processing method for causing an image processing device to execute:
determining a subject size in a frame of captured image data;
setting a cutout frame on a basis of a plurality of pieces of composition data selected according to a ratio between a subject size and a frame size of captured image data among a plurality of pieces of composition data having different ratios between a subject size and a frame size; and
performing cutout processing on a frame of captured image data with a set cutout frame.

10. A program for causing an image processing device to execute processing of:
determining a subject size in a frame of captured image data;
setting a cutout frame on a basis of a plurality of pieces of composition data selected according to a ratio between a subject size and a frame size of the captured image data among a plurality of pieces of composition data having different ratios between a subject size and a frame size; and
performing cutting on a frame of captured image data with a set cutout frame.
